(19) United States
(12) Patent Application Publication
(10) Pub. No.: US 2011/0043932 A1
(43) Pub. Date: Feb. 24, 2011

(54) LENS DEVICE

(75) Inventors: Yoshimitsu Nomura, Saitama-shi (JP); Tatsuhiko Obayashi, Minami-ashigara-shi (JP); Seiichi Watanabe, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/812,896

(22) PCT Filed: Jan. 21, 2009
(86) PCT No.: PCT/JP2009/051287

§ 371 Date: Jul. 14, 2010

(30) Foreign Application Priority Data
Jan. 23, 2008 (JP) 2008-012646

(51) Int. Cl. G02B 7/02

(52) U.S. Cl. 359/819

(57) ABSTRACT

A lens device (10) is constituted of a lens barrel (12), and first to third lenses (14) to (16) accommodated in the lens barrel (12). The first to the third lenses (14) to (16) are formed from plastic nanocomposite material that is plastic material in which inorganic fine particles are dispersed. First to third cushioning members (18a) to (18c) are provided between rim surfaces of flanges (14b) to (16b) of the first to the third lenses (14) to (16) and inner circumferential surfaces of the lens barrel (12), respectively. Thus, corner portions (14c) to (16c) of the first to the third lenses (14) to (16) are prevented from chipping on contact with the inner circumferential surfaces of the lens barrel (12).

### TECHNICAL FIELD

The present invention relates to a lens device having a lens barrel in which a lens formed from plastic nanocomposite material is accommodated.

### BACKGROUND ART

Imaging apparatuses, for example, a mobile phone with a camera, are provided with a lens device constituted of a taking lens and a lens barrel for accommodating the taking lens. Plastic lenses and glass lenses are known to be used as the taking lenses. In particular, the plastic lenses are superior to the glass lenses in light weight, productivity, and cost. In addition, since the plastic lenses are formed by molding, the plastic lenses can be formed into complicated shapes such as aspherical lenses. For these reasons, the plastic lenses are more commonly used than the glass lenses.

Although the plastic lenses are superior to the glass lenses in the above described features, it is difficult to increase the refractive indices of the plastic lenses to the same level as those of the glass lenses. To solve this problem, methods to form plastic lenses from plastic nanocomposite materials are known (for example, see Japanese Patent Laid-Open Publication No. 2007-211164). The plastic nanocomposite material is a plastic material such as thermoplastic polymer in which inorganic fine particles are dispersed. The plastic lenses formed from such plastic nanocomposite material have higher refractive indices than the ordinary plastic lenses, and therefore are becoming rapidly widespread as taking lenses for the mobile phones with cameras.

In spite of the above advantages, the plastic lenses formed from the plastic nanocomposite materials are more brittle than the ordinary plastic lenses, and therefore have lower impact resistance. Corners of a flange of the plastic lens may be chipped when a rim surface of the flange comes in contact with an inner circumferential surface of the lens barrel. The chipped pieces are regarded as foreign matter. When the lens device is subject to impact, the plastic lens may be damaged easily.

In view of the foregoing, an object of the present invention is to provide a lens device that prevents chipping of a plastic lens formed from a plastic nanocomposite material.

### DISCLOSURE OF INVENTION

In order to achieve the above objects and other objects, a lens device having a lens barrel accommodating a lens has a cushioning member provided between a rim surface of the lens and an inner circumferential surface of the lens barrel. The lens is formed from a plastic nanocomposite material that contains inorganic fine particles and thermoplastic polymer. The thermoplastic polymer has a functional group in at least one of a main chain end and a side chain. The functional group is chemically bonded to at least one of the inorganic fine particles.

It is preferred that chamfering is performed to a corner portion of the lens. Thereby, chipping of the corner portions of the lens is further prevented. It is preferred that rubber hardness in conformity with ISO (International Organization of Standardization) 7619 Type A of the cushioning member is in a range from at least 10 to at most 80. Thereby, the chipping of the corner portions of the lens is further prevented.

It is preferred that the lens barrel accommodates the plural lenses aligned along an optical axis direction and parallel to each other, and the cushioning member extends in the optical axis direction so as to contact with the adjacent lenses.

The lens device of the present invention provides the cushioning member between the rim surface of the lens and the inner circumferential surface of the lens barrel. Accordingly, the corner portions or the like of the lens formed from the plastic nanocomposite material are prevented from chipping when coming in contact with the inner circumferential surface of the lens barrel. In addition, breakage of the lens is prevented when the lens device is subject to impact.

### BRIEF DESCRIPTION OF DRAWINGS

FIG. 1 is a section view of a lens device of the present invention;

FIG. 2 is a section view of a mold when a lens barrel is formed;

FIG. 3 is a section view of a mold when a cushioning member is formed;

FIG. 4 is a section view of the mold after the cushioning member is formed;

FIG. 5 is an enlarged view of a section of a lens of another embodiment with corner portions of the lens being R-chamfered; and

FIG. 6 is a section view of a lens device of another embodiment having cushioning members between flanges of the lenses.

### BEST MODE FOR CARRYING OUT THE INVENTION

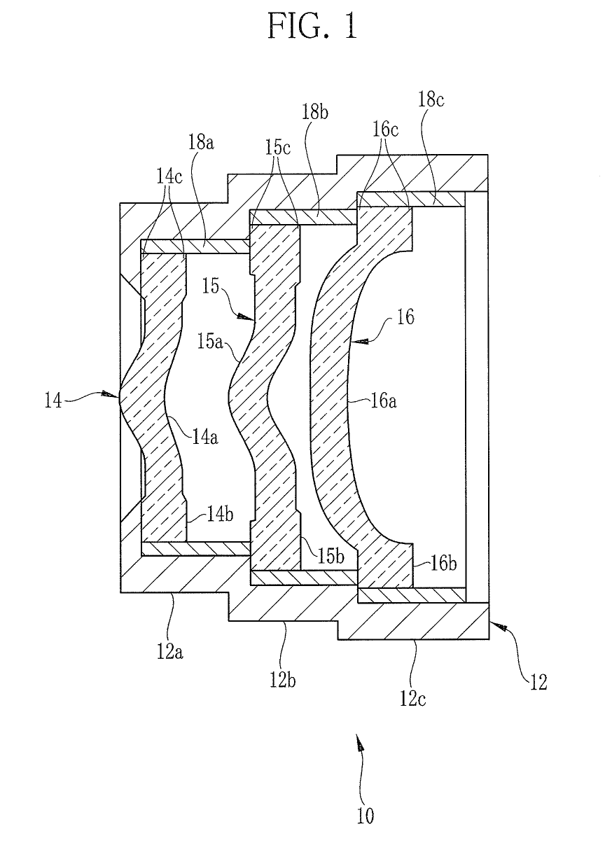

In FIG. 1, a lens device 10 is provided, for example, in a mobile phone with a camera (not shown). The lens device 10 is constituted of a lens barrel 12 and first to third lenses (hereinafter may simply be referred to as lenses) 14 to 16. The lens barrel 12 is formed from plastic such as polycarbonate or liquid crystal polymer, aluminum, or the like. The lens barrel 12 is constituted of a first barrel section 12a, a second barrel section 12b, and a third barrel section 12c molded in one-piece. The first to the third barrel sections (hereinafter may simply be referred to as barrel sections) 12a to 12c differ from each other in diameter. The first barrel section 12a in a forward portion of the lens barrel 12 has the smallest diameter. The third barrel section 12c in the rear of the lens barrel 12 has the largest diameter.

The first to the third lenses 14, 15, and 16 are attached and fixed to the first to the third barrel sections 12a, 12b, and 12c, respectively. The first lens 14 is constituted of a lens body 14a and a flange 14b. The second lens 15 is constituted of a lens body 15a and a flange 15b. The third lens 16 is constituted of a lens body 16a and a flange 16b. The flanges 14b to 16b have approximately annular shapes, and are provided along outer peripheries of the lens bodies 14a to 16a, respectively. The flanges 14b to 16b are fitted into the first to the third barrel sections 12a to 12c, respectively. Thus, the lens bodies 14a to 16a are fixed inside the lens barrel 12.

The first to the third lenses 14 to 16 are formed from plastic nanocomposite material (hereinafter simply referred to as nanocomposite material). The nanocomposite material is an organic-inorganic composite material containing inorganic fine particles and thermoplastic polymer. The thermoplastic polymer has a functional group located in a main chain or a side chain. The functional group is chemically bonded to at least one of the inorganic fine particles. More specifically, in the nanocomposite material, the inorganic fine particles are dispersed in the thermoplastic polymer. It should be noted that one or more kinds of inorganic fine particles may be dispersed in the plastic material. Hereinafter, examples of the thermoplastic polymer and inorganic fine particles used for forming the nanocomposite material are described.

[Thermoplastic Polymer]

A thermoplastic polymer (thermoplastic resin) effectively used for production of a plastic lens of the present invention has a functional group chemically bonded to at least one of inorganic fine particles, and located in at least one of a main chain end (polymer chain end) or a side chain.

Preferable examples of such thermoplastic polymer include:
(1) a thermoplastic polymer having at least one of functional groups in a side chain, and such functional group is selected from the following,

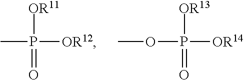

[Each of R¹¹, R¹², R¹³, and R¹⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, and —Si(OR¹⁵)ₘ₁R¹⁶₃₋ₘ₁ [each of R¹⁵ and R¹⁶ is a hydrogen atom, a substituted or unsubstituted alkyl group, a substituted or unsubstituted alkenyl group, a substituted or unsubstituted alkynyl group or a substituted or unsubstituted aryl group, and m1 is an integer from 1 to 3];
(2) a thermoplastic polymer having at least one of functional groups in at least a part of a main chain end, and such functional group is selected from the following,

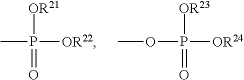

[Each of R²¹, R²², R²³, and R²⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, and —Si(OR²⁵)ₘ₂R²⁶₃₋ₘ₂ [each of R²⁵ and R²⁶ is a hydrogen atom, a substituted or unsubstituted alkyl group, a substituted or unsubstituted alkenyl group, a substituted or unsubstituted alkynyl group or a substituted or unsubstituted aryl group, m2 is an integer from 1 to 3]; and
(3) a block copolymer composed of a hydrophobic segment and a hydrophilic segment.
Hereinafter, the thermoplastic polymers (1) to (3) are detailed.

Thermoplastic Polymer (1)

The thermoplastic polymer (1) used in the present invention has a functional group chemically bonded to at least one of inorganic fine particles and located in a side chain. The examples of the “chemical bond” used herein include, for example, a covalent bond, an ionic bond, a coordinate bond, and a hydrogen bond. In a case where a thermoplastic polymer (1) has plural functional groups, each functional group may form a different chemical bond with at least one of inorganic fine particles. Whether a functional group is chemically bonded to inorganic particles or not is determined by the presence of a chemical bond between the functional group and the inorganic fine particles when the thermoplastic polymer and the inorganic fine particles are dispersed in an organic solvent. All or a part of the functional groups of the thermoplastic polymer are chemically bonded to inorganic fine particles.

By forming the chemical bonds between the inorganic fine particles and the functional group, the inorganic fine particles are stably dispersed in the thermoplastic polymer. Such functional group is selected from

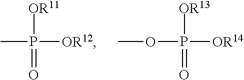

[Each of R¹¹, R¹², R¹³, and R¹⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, or —Si(OR¹⁵)ₘ₁R¹⁶₃₋ₘ₁ [each of R¹⁵ and R¹⁶ is a hydrogen atom, a substituted or unsubstituted alkyl group, a substituted or unsubstituted alkenyl group, a substituted or unsubstituted alkynyl group or a substituted or unsubstituted aryl group, and m1 is an integer from 1 to 3].

The alkyl group has preferably from one to 30 carbon atoms, and more preferably from one to 20 carbon atoms, and examples thereof include a methyl group, an ethyl group, and an n-propyl group. The substituted alkyl group includes, for example, an aralkyl group. The aralkyl group has preferably from 7 to 30 carbon atoms, and more preferably from 7 to 20 carbon atoms, and examples thereof include a benzyl group, and a p-methoxybenzyl group. The alkenyl group has preferably from 2 to 30 carbon atoms, and more preferably from 2 to 20 carbon atoms, and examples thereof include a vinyl group and a 2-phenylethenyl group. The alkynyl group has preferably from 2 to 20 carbon atoms, and more preferably from 2 to 10 carbon atoms, and examples thereof include an ethynyl group, and a 2-phenylethynyl group. The aryl group has preferably from 6 to 30 carbon atoms, and more preferably from 6 to 20 carbon atoms, and examples thereof include a phenyl group, a 2, 4, 6-tribromophenyl group, and a 1-naphthyl group. The aryl group used herein includes a heteroaryl group. Examples of substituents for the alkyl group, the alkenyl group, the alkynyl group, and the aryl group include a halogen atom (for example, a fluorine atom, a chlorine atom, a bromine atom, and an iodine atom) and an alkoxy group (for example, a methoxy group or an ethoxy group) in addition to the above-described alkyl group, the alkenyl group, the alkynyl group, and the aryl group. Preferable number of atoms, functional groups, and substituents for the R¹⁵ and R¹⁶ are the same as those for R¹¹, R¹², R¹³, and R¹⁴. The m1 is preferably 3.

Of the above functional groups, preferable are

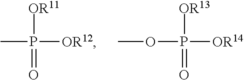

—SO₃H, —CO₂H, or —Si(OR¹⁵)ₘ₁R¹⁶₃₋ₘ₁. More preferable functional groups are

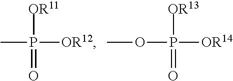

or —CO₂H. Especially preferable functional groups are

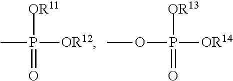

It is especially preferable that the thermoplastic polymer used in the present invention is a copolymer having a repeating unit represented by a general formula (1) below. Such copolymer is synthesized by copolymerization of vinyl monomers represented by a general formula (2) below.

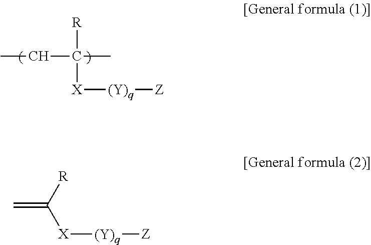

In the general formulae (1) and (2), “R” represents one of a hydrogen atom, a halogen atom, and a methyl group. “X” represents a bivalent linking group selected from a group consists of —CO₂—, —OCO—, —CONH—, —OCONH—, —OCOO—, —O—, —S—, —NH—, and a substituted or unsubstituted arylene group. It is more preferable that “X” is —CO₂— or a p-phenylene group.

“Y” represents a bivalent linking group having 1 to 30 carbon atoms. The number of the carbon atoms is preferably 1 to 20, more preferably 2 to 10, and furthermore preferably 2 to 5. More specifically, an alkylene group, an alkyleneoxy group, an alkyleneoxycarbonyl group, an arylene group, an aryleneoxy group, an aryleneoxycarbonyl group, and a combination of the above groups may be used. In particular, the alkylene group is preferable.

“q” represents an integer from zero to 18, more preferably zero to 10, furthermore preferably from zero to 5, and especially preferably zero or one.

“Z” represents a functional group selected from a group consists of

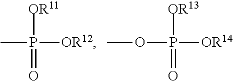

—SO₃H, —OSO₃H, —CO₂H and —Si(OR¹⁵)ₘ₁R¹⁶₃₋ₘ₁. Of these, preferable functional groups are

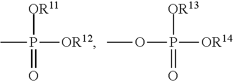

More preferable functional group is

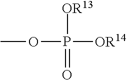

Here, definitions and specific examples of R¹¹, R¹², R¹³, R¹⁴, R¹⁵, R¹⁶ and ml are the same as those of the R¹¹, R¹², R¹³, R¹⁴, R¹⁵, R¹⁶ and ml previously described, except that each of R¹¹, R¹², R¹³, R¹⁴, R¹⁵, and R¹⁶ is a hydrogen atom or an alkyl group.

Specific examples of monomers represented by the general formula (2) are shown below. However, monomers usable in the present invention are not limited to these examples.

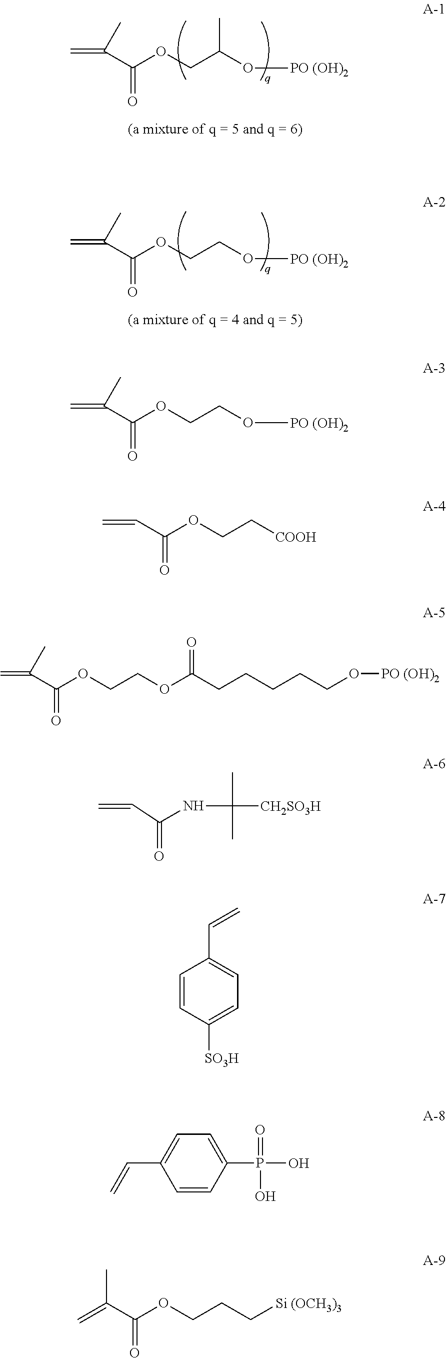

Other kinds of monomers copolymerizable with the monomer represented by the above general formula (2) are described in pages one to 483, in chapter 2 of “Polymer Handbook 2^{nd} ed.”, J. Brandrup, Wiley Interscienece (1975).

Specifically, for example, compounds having one addition-polymerizable unsaturated bond selected from styrene derivatives, 1-vinylnaphthalene, 2-vinylnaphthalene, vinylcarbazole, acrylic acid, methacrylic acid, acrylic esters, methacrylic esters, acrylamides, methacrylamides, allyl compounds, vinyl ethers, vinyl esters, dialkyl itaconates, and dialkyl esters or monoalkyl esters of fumaric acid, can be exemplified.

Examples of the styrene derivative include styrene, 2, 4, 6-tribromostyrene, 2-phenylstyrene.

Examples of the acrylic esters include methyl acrylate, ethyl acrylate, propyl acrylate, n-butyl acrylate, tert-butyl acrylate, chloroethyl acrylate, 2-hydroxyethyl acrylate, trimethylolpropane monoacrylate, benzyl acrylate, methoxybenzyl acrylate, furfuryl acrylate, and tetrahydrofurfuryl acrylate.

Examples of the methacrylic esters include methyl methacrylate, ethyl methacrylate, propyl methacrylate, butyl methacrylate, tert-butyl methacrylate, chloroethyl methacrylate, 2-hydroxyethyl methacrylate, trimethylolpropane monomethacrylate, benzyl methacrylate, methoxybenzyl methacrylate, furfuryl methacrylate, and tetrahydrofurfuryl methacrylate.

Examples of the acrylamides include acrylamide, N-alkyl acrylamide (with an alkyl group having 1 to 3 carbon atoms, such as a methyl group, an ethyl group, or a propyl group), N,N-dialkyl acrylamide (with an alkyl group having 1 to 6 carbon atoms), N-hydroxyethyl-N-methyl acrylamide and N-2-acetamideethyl-N-acetyl acrylamide.

Examples of the methacrylamides include methacrylamide, N-alkyl methacrylamide (with an alkyl group having 1 to 3 carbon atoms, such as a methyl group, an ethyl group, or a propyl group), N,N-dialkyl methacrylamide (with an alkyl group having 1 to 6 carbon atoms), N-hydroxyethyl-N-methyl methacrylamide and N-2-acetamideethyl-N-acetyl methacrylamide.

Examples of the allyl compounds include allyl esters (for example, allyl acetate, allyl caproate, allyl caprylate, allyl laurate, allyl palmitate, allyl stearate, allyl benzoate, allyl acetoacetate and allyl lactate), and allyl oxyethanol.

Examples of the vinyl ethers include alkyl vinyl ethers with an alkyl group having 1 to 10 carbon atoms, such as hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether and tetrahydrofurfuryl vinyl ether.

Examples of the vinyl esters include vinyl butyrate, vinyl isobutyrate, vinyl trimethyl acetate, vinyl diethyl acetate, vinyl pivalate, vinyl caproate, vinyl chloroacetate, vinyl dichloroacetate, vinyl methoxyacetate, vinyl butoxyacetate, vinyl lactate, vinyl-β-phenyl butylate and vinyl cyclohexyl carboxylate.

Examples of the dialkyl itaconates include dimethyl itaconate, diethyl itaconate and dibutyl itaconate. Examples of dialkyl esters or monoalkyl esters of the fumaric acid include dibutyl fumarate.

In addition, crotonic acid, itaconic acid, acrylonitrile, methacrylonitrile, maleonitrile and the like can be exemplified.

The thermoplastic polymer (1) used in the present invention has a number average molecular weight of preferably from 1,000 to 500,000, more preferably from 3,000 to 300,000, and especially preferably from 10,000 to 100,000. In a case where the thermoplastic polymer (1) has the number average molecular weight of at most 500,000, processability of the thermoplastic polymer (1) improves, and where it is at least 1,000, mechanical strength increases.

The “number average molecular weight” used herein is a polystyrene equivalent molecular weight based on detection by a differential refractometer of a GPC analyzer with columns of TSK gel GMHXL, TSK gel G4000HxL, and TSK gel G2000HxL (trade names of Tosoh Corporation) using tetrahydrofuran as a solvent.

In the thermoplastic polymer (1) used in the present invention, the average number of the functional group that bonds to the inorganic fine particles per polymer chain is preferably from 0.1 to 20, more preferably from 0.5 to 10, and especially preferably from 1 to 5. Gelation and an increase in viscosity in a solution state caused by coordination of the thermoplastic polymer (1) to plural inorganic fine particles is prevented where the average number of the functional group is at most 20 per polymer chain. The inorganic fine particles are dispersed stably where the average number of the functional group per polymer chain is at least 0.1.

A glass transition temperature of the thermoplastic polymer (1) used in the present invention is preferably 80° C. to 400° C., and more preferably 130° C. to 380° C. An optical component having sufficient heat resistance is produced from a thermoplastic polymer having the glass transition temperature of at least 80° C. Processability is improved by using the thermoplastic polymer having the glass transition temperature of at most 400° C.

Rayleigh scattering is likely to occur where there is a significant difference between a refractive index of the thermoplastic polymer (1) and a refractive index of the inorganic fine particles. As a result, the amount of the inorganic fine particles to be dispersed in the thermoplastic polymer (1) needs to be reduced to maintain transparency of a molded product. In a case where the refractive index of the thermoplastic polymer (1) is approximately 1.48, the transparent molded product having the refractive index in a level of 1.60 can be provided. To achieve the refractive index of at least 1.65, the refractive index of the thermoplastic polymer (1) used in the present invention is preferably at least 1.55, and more preferably at least 1.58. These refractive indices are measured at 589 nm wavelength at 22° C.

The thermoplastic polymer (1) used in the present invention has a light transmittance of preferably at least 80%, more preferably at least 85%, and especially preferably at least 88%, at 589 nm wavelength with the thickness of 1 mm.

Preferable specific examples of the thermoplastic polymer (1) that can be used in the present invention are shown below, but the thermoplastic polymer that can be used in the present invention is not limited to the following examples.

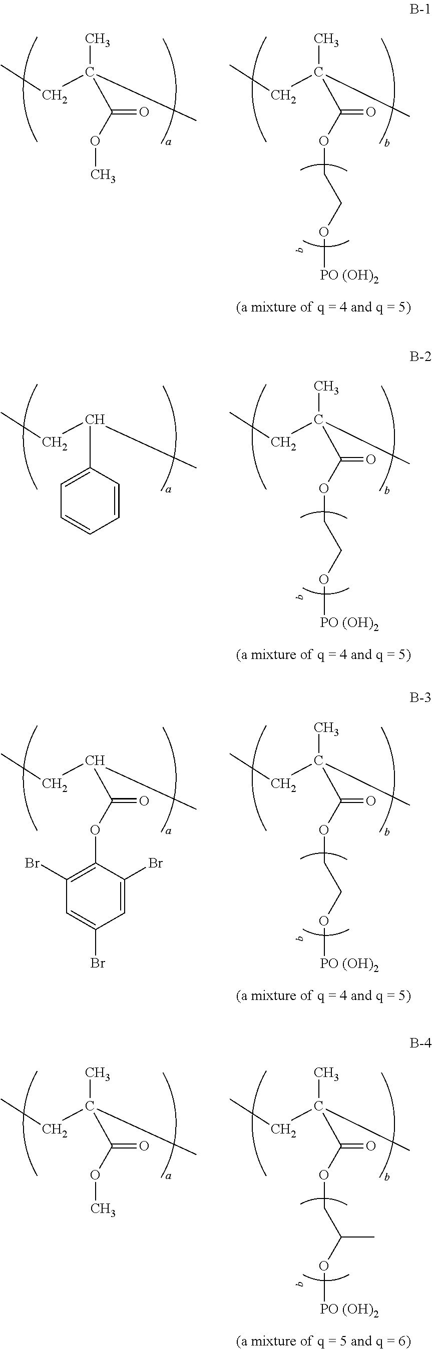

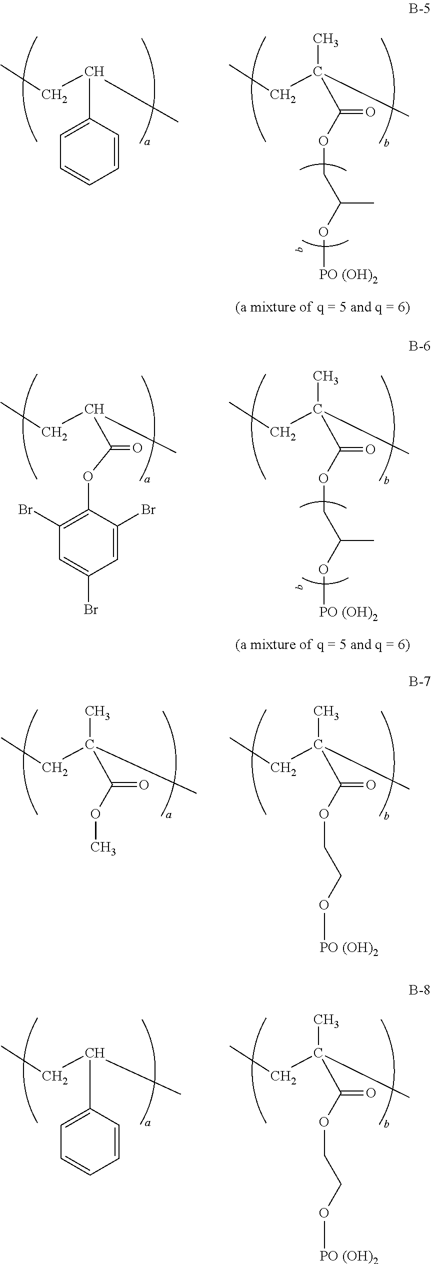

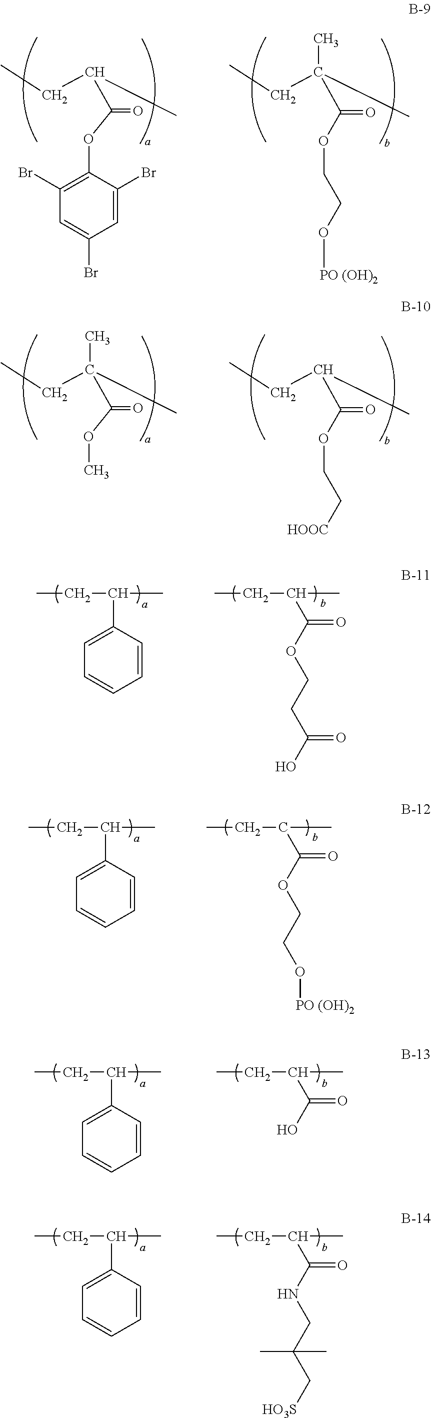

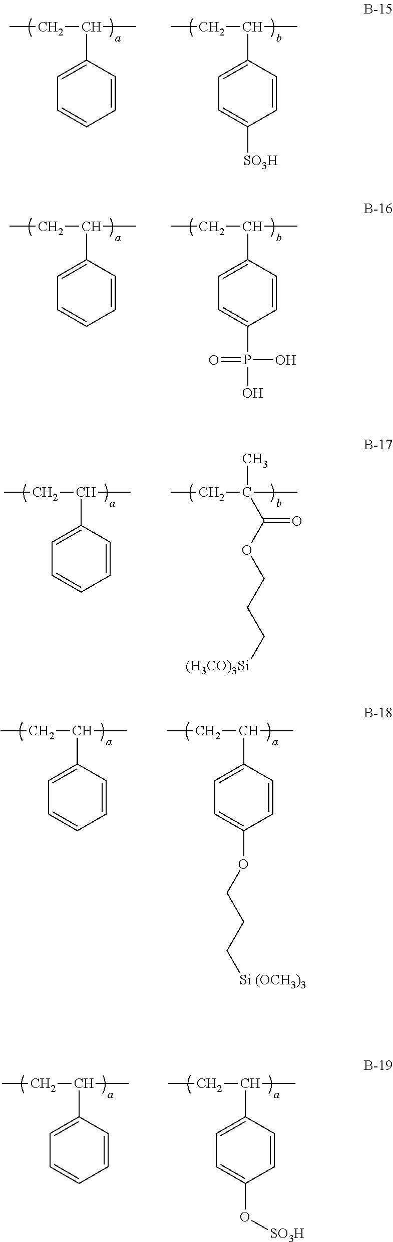

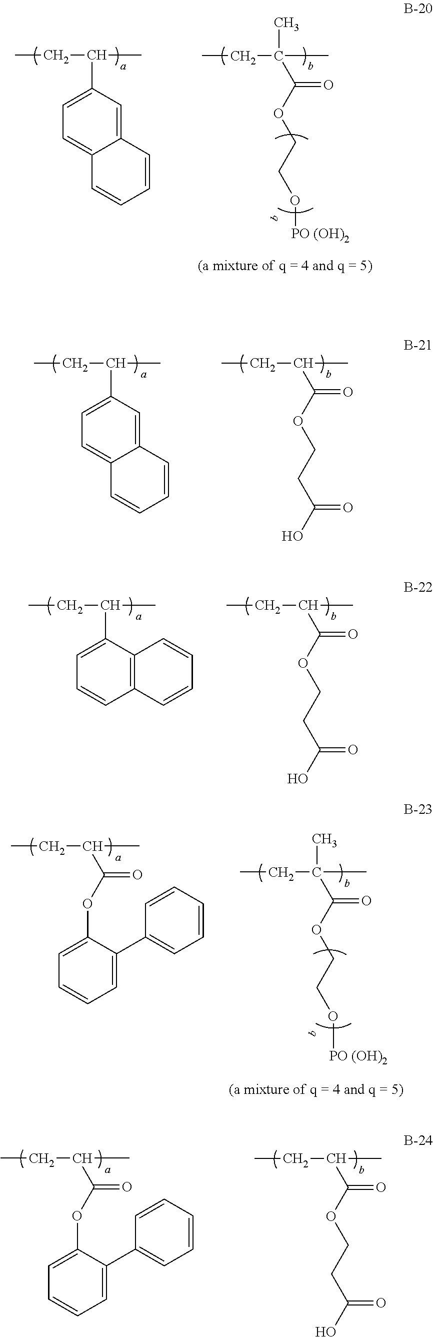

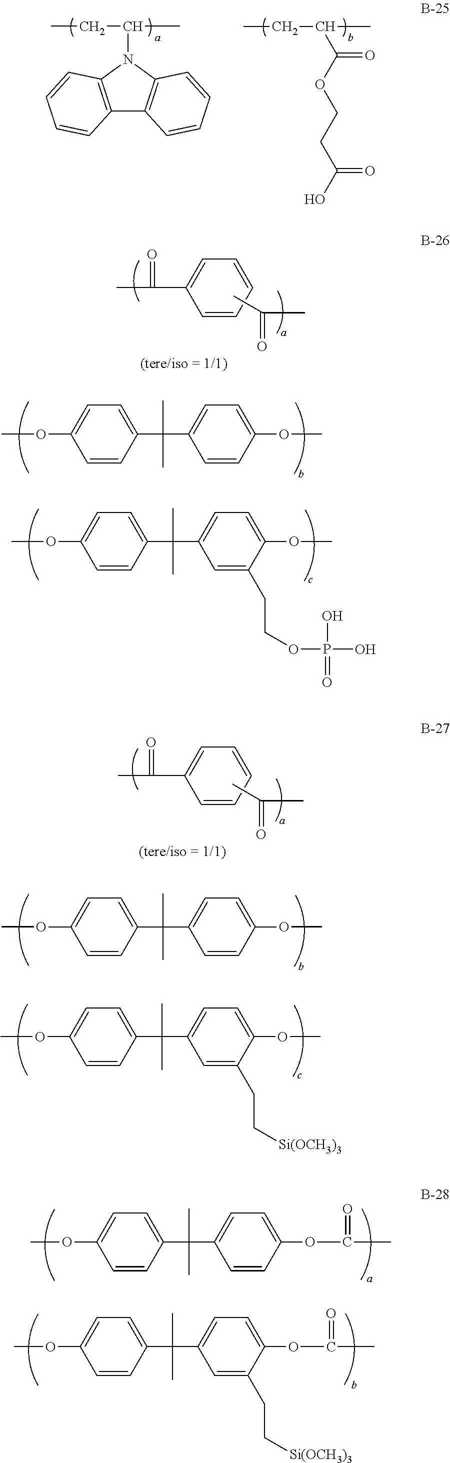

The thermoplastic polymer (1) may be one kind or a mixture of two or more kinds of the above-mentioned thermoplastic polymers. In addition, the thermoplastic polymer (1) may be mixed with a thermoplastic polymer (2) and/or a thermoplastic polymer (3).

Thermoplastic Polymer (2)

The thermoplastic polymer (2) used in the present invention has a functional group chemically bonded to at least one of inorganic fine particles, and located in at least a part of a main chain end. The functional group may be present in one or both of the main chain ends. However, it is preferable that the functional group is present only in one of the main chain ends. Plural functional groups may be present in the main chain end. The “main chain end” refers to a moiety of the polymer excluding a repeating unit and a structure sandwiched between repeating units. The “chemical bond” is considered similar to that in the above-described thermoplastic polymer (1).

The functional group chemically bonded to at least one of inorganic fine particles is a selected one of

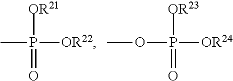

[Each of R²¹, R²², R²³, and R²⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, and —Si(OR²⁵)ₘ₂R²⁶₃₋ₘ₂ [each of R²⁵ and R²⁶ is a hydrogen atom, a substituted or unsubstituted alkyl group, a substituted or unsubstituted alkenyl group, a substituted or unsubstituted alkynyl group or a substituted or unsubstituted aryl group, m2 is an integer from 1 to 3].

In the case each of R²¹, R²², R²³, R²⁴, R²⁵, and R²⁶ is a substituted or unsubstituted alkyl group, a substituted or unsubstituted alkenyl group, a substituted or unsubstituted alkynyl group, or a substituted or unsubstituted aryl group, preferable number of carbon atoms, functional groups, and substituents for R²¹, R²², R²³, R²⁴, R²⁵, and R²⁶ are the same as those for R¹¹, R¹², R¹³, R¹⁴, (R¹⁵, and R¹⁶). It is preferable that m2 is 3.

Of the above functional groups, preferable are

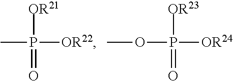

—SO₃H, —CO₂H, and —Si (OR²⁵)ₘ₂R²⁶₃₋ₘ₂. More preferable functional groups are

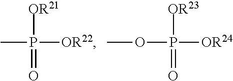

—SO₃H, and —CO₂H. Especially preferable functional groups are

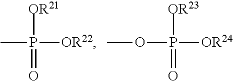

and —SO₃H.

A basic skeleton of the thermoplastic polymer (2) in the present invention is not particularly limited. A well known polymer structure such as that of poly(meth)acrylic ester, polystyrene, polyvinyl carbazole, polyarylate, polycarbonate, polyurethane, polyimide, polyether, polyether sulfone, polyether ketone, polythioether, cycloolefin polymer, and cycloolefin copolymer can be employed. A vinyl polymer, a polyarylate and an aromatic group-containing polycarbonate are preferable, and a vinyl polymer is more preferable. Specific examples are the same as those described for the thermoplastic polymer (1).

The thermoplastic polymer (2) used in the present invention has a refractive index of preferably at least 1.50, more preferably at least 1.55, further preferably at least 1.60, and especially preferably at least 1.65. The refractive index used herein is measured using an Abbe's refractometer (a product of Atago, Model: DR-M4) with incident light of 589 nm wavelength.

The thermoplastic polymer (2) used in the present invention has a glass transition temperature of preferably from 50° C. to 400° C., and more preferably from 80° C. to 380° C. In a case where the thermoplastic polymer (2) has a glass transition temperature of at least 50° C., heat resistance increases. In a case where the thermoplastic polymer (2) has a glass transition temperature of at most 400° C., processing becomes facilitated.

The thermoplastic polymer (2) used in the present invention has a light transmittance of preferably at least 80%, and more preferably at least 85%, at 589 nm wavelength with the thermoplastic polymer thickness of 1 mm.

The thermoplastic polymer (2) used in the present invention has a number average molecular weight of preferably from 1,000 to 500,000. The number average molecular weight is preferably from 3,000 to 300,000, and more preferably from 5,000 to 200,000, and especially preferably from 10,000 to 100,000. With the use of the thermoplastic polymer (2) having the number average molecular weight of at least 1,000, mechanical strength increases. With the use of the thermoplastic polymer (2) having the number average molecular weight of at most 500,000, processability of the thermoplastic polymer improves.

A method of introducing the functional group into the main chain end is not particularly limited. For example, as described in Chapter 3 Terminal Reactive Polymer of “New Polymer Experimental Studies 4, Synthesis and Reaction of Polymer (3) Reaction and Decomposition of Polymer” edited by the Society of Polymer Science, Japan, the functional group may be introduced at the time of polymerization, or after polymerization. In the case the functional group is introduced after polymerization, the polymer is isolated and then subjected to terminal functional group transformation or main chain decomposition. It is also possible to use polymer reactions such as a method of synthesizing polymer by polymerization using an initiator, a terminator, a chain transfer agent or the like having a functional group and/or a protected functional group, and a method in which a phenol terminal of polycarbonate synthesized from, for example, bisphenol A is modified with a reacting agent containing a functional group. For example, radical polymerization of vinyl monomer by a chain transfer method using a sulfur-containing chain transfer agent, described in pages 110-112 of “New Polymer Experimental Studies 2, Synthesis and Reaction of Polymer (1) Synthesis of Addition-Type Polymer” edited by the Society of Polymer Science, Japan; living cationic polymerization using a functional group-containing initiator and/or a functional group-containing terminator, described in pages 255-256 of “New Polymer Experimental Studies 2, Synthesis and Reaction of Polymer (1) Synthesis of Addition-Type Polymer” edited by the Society of Polymer Science, Japan; and ring-opening metathesis polymerization using a sulfur-containing chain transfer agent, described in pages 7020-7026 of Macromolecules, vol. 36, (2003) can be exemplified.

Preferable specific examples of the thermoplastic polymer (2) that can be used in the present invention are shown below as compounds P-1 to P-22, but the thermoplastic polymer (2) is not limited to such examples. The structure in parentheses shows a repeating unit, and x and y of the repeating unit represent a copolymerization ratio (molar ratio).

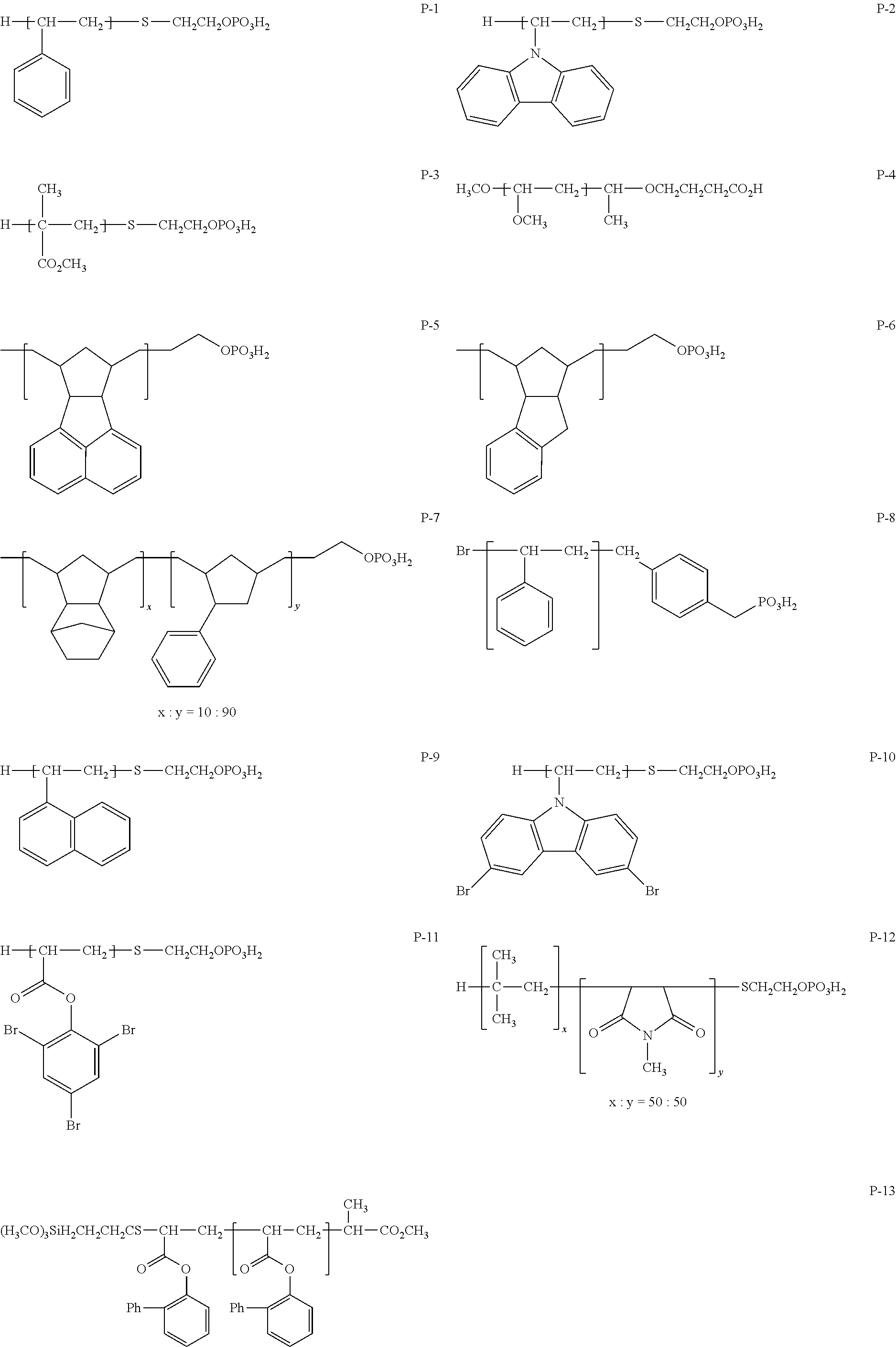

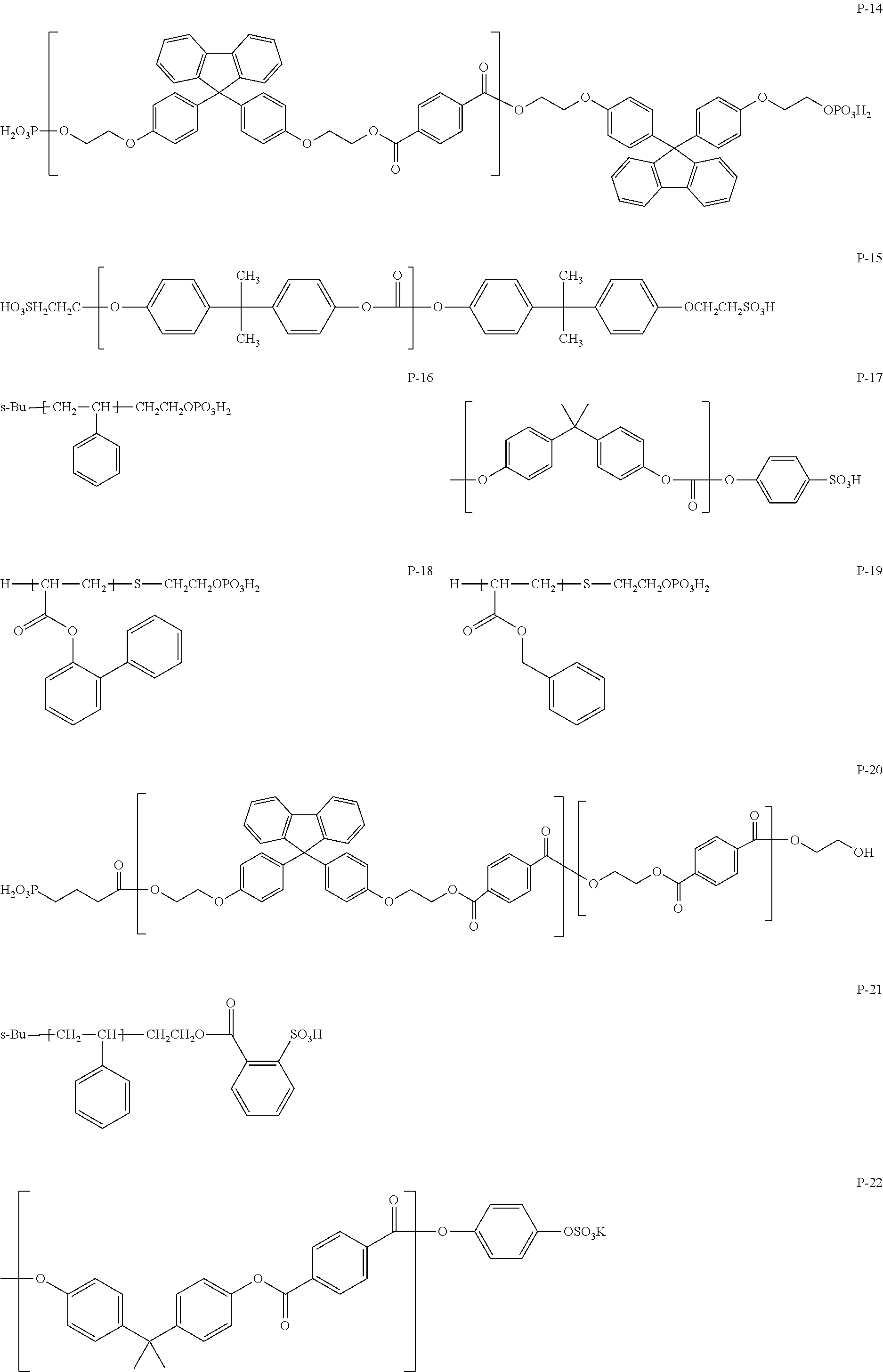

One kind or a mixture of two or more kinds of the above-mentioned thermoplastic polymers (2) may be used. These thermoplastic polymers (2) may contain other copolymerization components.

Thermoplastic Polymer (3)

A thermoplastic polymer (3) used in the present invention is a block copolymer composed of a hydrophobic segment (A) and a hydrophilic segment (B).

The hydrophobic segment(s) (A) make up the polymer that is not soluble in water nor methanol. The hydrophilic segment(s) (B) make up the polymer soluble in at least one of water and methanol. Types of the block copolymer include AB type, B¹AB² type, and A¹BA² type. In the B¹AB² type, two hydrophilic segments B¹ and B² may be the same or different. In the A¹BA² type, two hydrophobic segments A¹ and A² may be the same or different. In view of dispersibility, the block copolymers of the AB type or the A¹BA² type are preferable. In view of production suitability, the AB type or the ABA type (the A¹BA² type in which the two hydrophobic segments A¹ and A² are the same) is preferable, and the AB type is especially preferable.

Each of the hydrophobic segment (A) and the hydrophilic segment (B) may be selected from well known polymers such as vinyl polymer obtained by polymerization of vinyl monomers, polyether, ring-opening metathesis polymerization polymer and condensation polymer (polycarbonate, polyester, polyamide, polyether ketone, polyether sulfone, and the like). In particular, vinyl polymer, ring-opening metathesis polymerization polymer, polycarbonate, and polyester are preferable. In view of production suitability, vinyl polymer is more preferable.

Examples of vinyl monomer (a) forming the hydrophobic segment (A) include the following: acrylic esters, methacryl esters (an ester group is a substituted or unsubstituted aliphatic ester group or a substituted or unsubstituted aromatic ester group, for example, a methyl group, a phenyl group, a naphthyl group, or the like);

acryl amides, methacryl amides, more specifically, N-monosubstituted acrylamides, N-disubstituted acrylamides, N-monosubstituted methacrylamides, N-disubstituted methacrylamides (substituents of a monosubstitution product and disubstitution product include a substituted or unsubstituted aliphatic group, and a substituted or unsubstituted aromatic group, for example, a methyl group, a phenyl group, a naphthyl group, or the like);

olefins, more specifically, dicyclopentadiene, norbornene derivative, ethylene, propylene, 1-buten, 1-penten, vinyl chloride, vinylidene chloride, isoprene, chloroprene, butadiene, 2,3-dimethylbutadiene, and vinyl carbazole; styrenes, more specifically, styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, tribromostyrene, and vinylbenzoic acid methyl ester; and

vinyl ethers, more specifically, methyl vinyl ether; butyl vinyl ether, phenyl vinyl ether, and methoxyethyl vinyl ether; other monomers such as butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methylvinyl ketone, phenylvinyl ketone, methoxyethyl vinyl ketone, N-vinyl oxazolidone, N-vinyl pyrrolidone, vinylidene chloride, methylene malononitrile, vinylidene, diphenyl-2-acryloyloxyethyl phosphate, diphenyl-2-methacryloyloxyethyl phosphate, dibutyl-2-acryloyloxyethyl phosphate, and dioctyl-2-methacryloyloxyethyl phosphate.

In particular, acrylic esters and methacrylic esters whose ester group is an unsubstituted aliphatic group, or a substituted or unsubstituted aromatic group; N-monosubstituted acrylamides, N-disubstituted acrylamides, N-monosubstituted methacrylamides and N-disubstituted methacrylamides whose substituent is an unsubstituted aliphatic group, or substituted or unsubstituted aromatic group; and styrenes are preferable. Acrylic esters and methacryl esters whose ester group is substituted or unsubstituted aromatic group; and styrenes are more preferable.

Examples of the vinyl monomer (b) forming the hydrophilic segment (B) include the following: acrylic acid, methacrylic acid, acrylic esters and methacrylic esters having a hydrophilic substituent at an ester moiety; styrenes having a hydrophilic substituent at an aromatic ring; vinyl ethers, acrylamides, methacryl amides, N-monosubstituted acrylamides, N-disubstituted acrylamides, N-monosubstituted methacrylamides, and N-disubstituted methacrylamides having a hydrophilic substituent.

The hydrophilic substituent preferably has a functional group selected from a group consists of

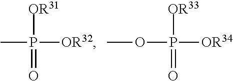

[Each of R³¹, R³², R³³, and R³⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, —OH, and —Si (OR³⁵)ₘ₃R³⁶₃₋ₘ₃ [each of R³⁵ and R³⁶ is a hydrogen atom, a substituted or unsubstituted alkyl group, a substituted or unsubstituted alkenyl group, a substituted or unsubstituted alkynyl group, or a substituted or unsubstituted aryl group, m3 is an integer from 1 to 3]. In a case where each of R³¹, R³², R³³, R³⁴, R³⁵, and R³⁶ is a substituted or unsubstituted alkyl group, a substituted or unsubstituted alkenyl group, a substituted or unsubstituted alkynyl group, or a substituted or unsubstituted aryl group, preferable number of atoms, functional groups, and substituents for R³¹, R³², R³³, R³⁴, R³⁵, and R³⁶ are the same as those for R¹¹, R¹², R¹³, R¹⁴, (R¹⁵, and R¹⁶). The m3 is preferably 3.

The functional group is preferably

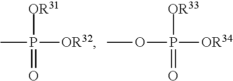

—CO₂H, or —Si(OR³⁵)m₃R³⁶₃₋ₘ₃, and more preferably,

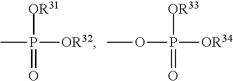

and —CO₂H,

and especially preferably,

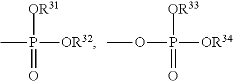

In the invention, it is preferable that the block copolymer has a functional group selected from

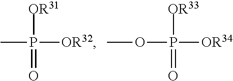

—SO₃H, —OSO₃H, —CO₂H, —OH, and —Si (OR³⁵)m₃R³⁶₃₋ₘ₃, and a content of the functional group is at least 0.05 mmol/g and at most 5.0 mmol/g.

In particular, the hydrophilic segment (B) is preferably acrylic acid, methacrylic acid, acrylic ester or methacrylic ester with a hydrophilic substituent at the ester moiety, and styrene having a hydrophilic substituent in an aromatic ring.

The hydrophobic segment (A) formed of the vinyl monomer (a) may also contain the vinyl monomer (b) within a range of not changing the hydrophobic property. It is preferable that a molar ratio between the vinyl monomer (a) and the vinyl monomer (b) contained in the hydrophobic segment (A) is 100:0 to 60:40.

The hydrophilic segment (B) formed of the vinyl monomer (b) may also contain the vinyl monomer (a) within a range of not changing the hydrophilic property. It is preferable that a molar ratio between the vinyl monomer (b) and the vinyl monomer (a) contained in the hydrophilic segment (B) is 100:0 to 60:40.

Each of the vinyl monomers (a) and (b) may be composed of one kind or two or more kinds of monomers. The vinyl monomers (a) and (b) are selected in accordance with the purpose (for example, to adjust acid content, to adjust glass transition temperature (Tg), to adjust solubility in organic solvent or water, or to adjust dispersion stability).

A content of the functional group relative to the total amount of the block copolymer is preferably 0.05 mmol/g to 5.0 mmol/g, and more preferably, 0.1 mmol/g to 4.5 mmol/g, and especially preferably 0.15 mmol/g to 3.5 mmol/g. In a case where the content of the functional group is too low, dispersion suitability may be reduced. In a case where the content of the functional group is too high, water solubility may become too high or the nanocomposite material may be gelated. In the block copolymer, the functional groups may form salts with cations such as alkali metal ions (for example, Na⁺, K⁺, or the like) or ammonium ions.

The number average molecular weight of the block copolymer is preferably 1000 to 100000, more preferably 2000 to 80000, and especially preferably 3000 to 50000. The block copolymer with the number average molecular weight of at least 1000 forms a stable dispersion. The block copolymer with the number average molecular weight of at most 100000 increases organic solvent solubility.

A refractive index of the block copolymer used in the present invention is preferably at least 1.50, more preferably at least 1.55, furthermore preferably at least 1.60, and especially preferably at least 1.65. The refractive index used herein is measured using Abbe's refractometer (a product of Atago, model: DR-M4) with incident light of 589 nm wavelength.

A glass transition temperature of the block copolymer used in the present invention is preferably in a range from 80° C. to 400° C., and more preferably 130° C. to 380° C. The block copolymer with the glass transition temperature of at least 80° C. increases heat resistance. The block copolymer with the glass transition temperature of at most 400° C. improves processability.

It is preferable that the block copolymer used in the present invention has optical transmittance of at least 80% measured at the wavelength of 589 nm with the thickness of 1 mm. It is more preferable that the optical transmittance is at least 85%.

Specific examples of the block copolymers (illustrated compounds of P-1 to P-20) are listed in the following. However, the block copolymers used in the present invention are not limited to the following specific examples.

TABLE 1
AB

| | | mol | | mol | molecular |
|---|---|---|---|---|---|
| No. | —A— | % | —B— | % | weight |
| P-1 | 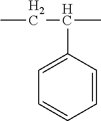 | 90 | 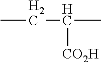 | 10 | 31000 |
| P-2 | 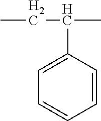 | 95 | 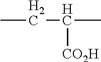 | 5 | 28000 |
| P-3 | 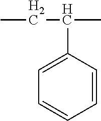 | 80 | 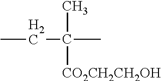 | 20 | 25000 |
| P-4 | 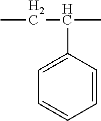 | 90 | 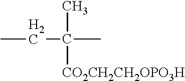 | 10 | 30000 |
| P-5 | 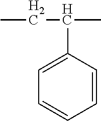 | 85 | 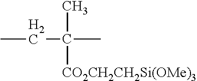 | 15 | 22000 |
| P-6 | 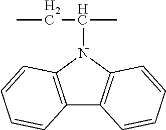 | 88 | 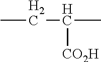 | 12 | 26000 |
| P-7 | 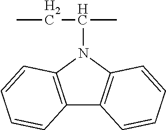 | 92 | 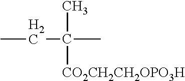 | 8 | 30000 |
| P-8 | 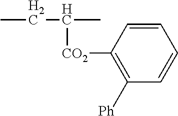 | 90 | 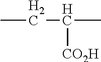 | 10 | 33000 |
| P-9 | 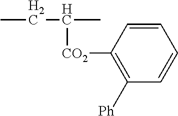 | 93 | 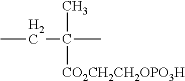 | 7 | 34000 |
| P-10 | 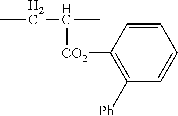 | 80 | 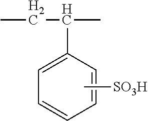 | 20 | 24000 |
| P-11 | 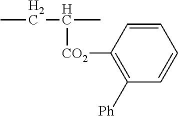 | 90 | 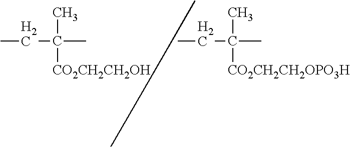 | 10 | 27000 |
| P-12 | 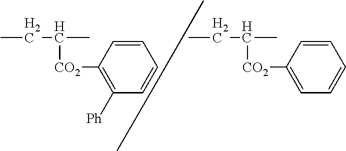 | 95 | 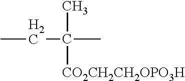 | 5 | 30000 |

TABLE 2
AB

| | | mol | | mol | molecular |
|---|---|---|---|---|---|
| No. | —A— | % | —B— | % | weight |
| P-13 | 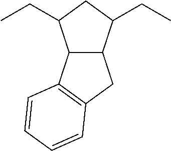 | 90 | 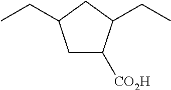 | 10 | 35000 |
| P-14 | 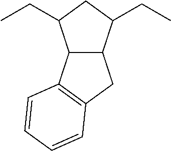 | 95 | 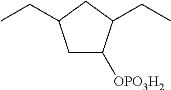 | 5 | 30000 |
| P-15 | 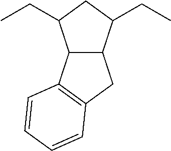 | 80 | 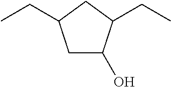 | 20 | 31000 |
| P-16 | 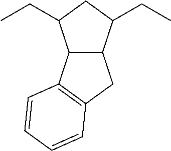 | 95 | 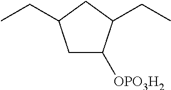 | 5 | 29000 |
| P-17 | 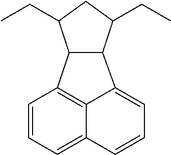 | 88 | 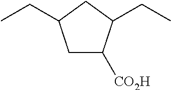 | 12 | 33000 |
| P-18 | 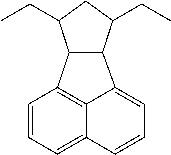 | 90 | 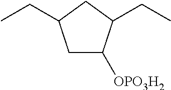 | 10 | 28000 |
| P-19 | 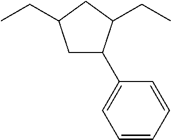 | 85 | 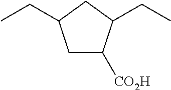 | 15 | 35000 |
| P-20 | 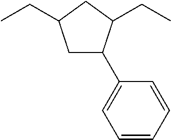 | 93 | 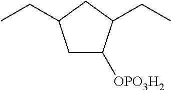 | 7 | 36000 |

The block copolymer is synthesized utilizing living radical polymerization and living ion polymerization, and techniques to protect carboxyl group or introduce a functional group to a polymer as necessary. It is also possible to synthesize the block copolymer by radical polymerization of polymers having terminal functional groups, and formation of bonds between polymers having terminal functional groups. In particular, it is preferable to utilize living radical polymerization and living ion polymerization in view of molecular weight control and yield of block copolymer. Production methods of the block copolymer are described in, for example, “Synthesis and reaction of polymer (1)” edited by The Society of Polymer Science, Japan, and published by Kyoritsu Shuppan, Co., Ltd. (1992), “Precision polymerization” edited by Chemical Society of Japan, and published by Japan Scientific Societies Press (1993), “Synthesis reaction of polymer (1)” edited by The Society of Polymer Science, Japan, and published by Kyoritsu Shuppan Co., Ltd. (1995), ‘Telechelic Polymer: Synthesis, Characterization, and Applications’ by R. Jerome, et al. in pages 837 to 906 of “Progress in Polymer Science”, Vol. 16 (1991), ‘Light-induced synthesis of block and graft copolymers’ by Y. Yagci et al, in pages 551 to 601 of “Progress in Polymer Science”, Vol. 15 (1990), and U.S. Pat. No. 5,085,698.

One kind or a mixture of two or more kinds of the above-described block copolymers may be used.

[Inorganic Fine Particles]

The inorganic fine particles (inorganic nanoparticles) used in the present invention include, for example, oxide fine particles and sulfide fine particles, more specifically, zirconium oxide fine particles, zinc oxide fine particles, titanium oxide fine particles, tin oxide fine particles, and zinc sulfide fine particles. However, the inorganic fine particles are not limited to those. Of those, metal oxide fine particles are especially preferable. In particular, one selected from the group consists of zirconium oxide fine particles, zinc oxide fine particles, tin oxide fine particles and titanium oxide fine particles is preferable, and one selected from the group consists of zirconium oxide fine particles, zinc oxide fine particles, and titanium oxide fine particles is more preferable. Furthermore, it is especially preferable to use zirconium oxide fine particles with low photocatalytic activity and excellent transparency in the visible light region. In the invention, a dispersion of two or more kinds of the above inorganic fine particles may be used in view of refractive index, transparency, and stability. To meet purposes such as reducing photocatalytic activity and a water absorption ratio, the above inorganic fine particles may be doped with different kinds of elements, and surfaces of the inorganic fine particles may be covered with dissimilar metal oxide such as silica and alumina. It is also possible that the inorganic fine particles are surface-modified with silane coupling agent, titanate coupling agent or the like.

Production methods of inorganic fine particles used in the present invention are not particularly limited, and any well-known method can be used. For example, desired fine oxide particles are produced using metal halide or metal alkoxide as a raw material, and hydrolyzing the raw material in a reaction system containing water.

Specifically, following methods to prepare zirconium oxide fine particles and its suspension are known, and any of them may be used: a method to prepare zirconium oxide suspension in which a solution containing zirconium salt is neutralized by an alkali to obtain zirconium hydrate, and the obtained zirconium hydrate is dried and sintered and then dispersed in a solvent; a method to prepare zirconium oxide suspension in which a solution containing zirconium salt is hydrolyzed; a method in which zirconium oxide suspension is prepared by hydrolysis of a solution containing zirconium salt and then the prepared zirconium oxide suspension is ultrafiltered to obtain zirconium oxide; a method to prepare zirconium oxide suspension by hydrolysis of zirconium alkoxide; and a method to prepare zirconium oxide suspension by heating and applying pressure to a solution containing zirconium salt under hydrothermal condition.

Titanyl sulfate is exemplified as a raw material for the synthesis of titanium oxide fine particles. Zinc salts such as zinc acetate and zinc nitrate are exemplified as raw materials for the synthesis of zinc oxide fine particles. Metal alkoxides such as tetraethoxysilane and titanium tetraisopropoxide are also suitable for raw materials of inorganic fine particles. The synthetic methods of such inorganic fine particles include, for example, a method described in pages 4603 to 4608 of Japanese Journal of Applied Physics, vol. 37 (1998), and pages 241 to 246 of Langmuir, vol. 16, issue 1 (2000).

In particular, where oxide fine particles are synthesized by a sol formation method, it is possible to use a procedure of forming a precursor such as a hydroxide, and then dehydrocondensing or peptizing the same with an acid or an alkali, and thereby forming a hydrosol, as in the synthesis of titanium oxide fine particles using titanyl sulfate as a raw material. In such a procedure, it is appropriate that the precursor is isolated and purified by any known method such as filtration and centrifugal separation in view of purity of a final product. The sol particles in the obtained hydrosol may be insolubilized in water and isolated by adding an appropriate surfactant such as sodium dodecylbenzene sulfonate (abbreviated DBS) or dialkylsulfosuccinate monosodium salt (a product of Sanyo Chemical Industries, Ltd., trade name “ELEMINOL JS-2”) to the hydrosol. For example, the well-known method described in pages 305 to 308 of “Color Material”, vol. 57, 6, (1984) can be used.

In addition to the above-described hydrolysis in water, a method of preparing inorganic fine particles in an organic solvent can be exemplified. In this case, the thermoplastic polymer used in the present invention may be dissolved in the organic solvent.

Examples of the solvent used in the above-mentioned methods include acetone, 2-butanone, dichloromethane, chloroform, toluene, ethyl acetate, cyclohexanone and anisole. One kind or a mixture of two or more kinds of the solvents may be used.

In a case where the number average particle size (diameter) of the inorganic fine particles used in the present invention is too small, intrinsic properties of the inorganic material forming the fine particles may not be exerted, and on the other hand, where it is too large, the impact of Rayleigh scattering becomes significant, reducing transparency of the nanocomposite material drastically. Therefore, the lower limit of the number average particle size of the inorganic fine particles used in the present invention is preferably at least 1 nm, more preferably at least 2 nm, and furthermore preferably at least 3 nm, and the upper limit thereof is preferably at most 15 nm, more preferably at most 10 nm, and furthermore preferably at most 7 nm. Namely, the number average particle size of the inorganic fine particles used in the present invention is preferably from 1 nm to 15 nm, more preferably 2 nm to 10 nm and furthermore preferably from 3 nm to 7 nm. The “number average particle size” used herein is measured using, for example, an X ray diffraction (XRD) device or a transmission electron microscope (TEM).

A refractive index of the inorganic fine particles used in the present invention is preferably in a range from 1.9 to 3.0 at the wavelength of 589 nm at 22° C., and more preferably in a range from 2.0 to 2.7, and especially preferably in a range from 2.1 to 2.5. In a case where the refractive index of the inorganic fine particles is at most 3.0, Rayleigh scattering is suppressed since a difference in refractive indices between the inorganic fine particles and the thermoplastic polymer is not so large. In a case where the refractive index of the inorganic fine particles is at least 1.9, a produced optical lens achieves a high refractive index.

The refractive index of the inorganic fine particles is obtained by, for example, measuring the refractive index of a transparent film made of the nanocomposite material containing the inorganic fine particles and the thermoplastic polymer used in the present invention with Abbe's refractometer (for example, a product of Atago, model: DM-M4), and converting the measured value using a refractive index of the thermoplastic polymer component separately measured. It is also possible to calculate the refractive index of the inorganic fine particles by measuring refractive indices of inorganic fine particle dispersions having different concentrations.

The content of inorganic fine particles in the nanocomposite material of the present invention is preferably 20 mass % to 95 mass %, and more preferably 25 mass % to 70 mass %, and especially preferably 30 mass % to 60 mass % in view of transparency and achieving a high refractive index. In the invention, a mass ratio between the inorganic fine particles and thermoplastic polymer (dispersion polymer) is preferably 1:0.01 to 1:100, and more preferably 1:0.05 to 1:10, and especially preferably 1:0.05 to 1:5 in view of dispersibility.

Although the above described first to the third lenses 14 to 16 formed from the nanocomposite material containing the thermoplastic polymer and the inorganic fine particles have the higher refractive indices than those of the ordinary plastic lenses, the first to the third lenses 14 to 16 are very brittle. In this embodiment, therefore, chipping of the corner portions 14c to 16c on contact with the inner circumferential surfaces of the barrel sections 12a to 12c of the lens barrel 12 is prevented, respectively. The corner portion 14c is between a front surface and a rim surface, and between a rear surface and a rim surface of the lens 14 (flange 14b). The corner portion 15c is between a front surface and a rim surface, and between a rear surface and a rim surface of the lens 15 (flange 15b). The corner portion 16c is between a front surface and a rim surface, and between a rear surface and a rim surface of the lens 16 (flange 16b). To be more specific, the first to the third cushioning members (hereinafter may simply be referred to as cushioning members) 18a to 18c are provided between the rim surfaces of the flanges 14b to 16b and the inner circumferential surfaces of the barrel sections 12a to 12c, respectively.

The first cushioning member 18a has an approximately annular shape, and is formed along the inner circumferential surface of the first barrel section 12a. In the same manner, the second and the third cushioning members 18b and 18c have approximately annular shapes and are formed along the inner circumferential surfaces of the second and the third barrel sections 12b and 12c, respectively. In this embodiment, therefore, the lenses 14 to 16 are retained by the cushioning members 18a to 18c, respectively.

The cushioning members 18a to 18c are formed of a material having rubber hardness in a range from at least 10 to at most 80 when measured in conformity with ISO 7619 Type A (corresponding to JIS K 6253 Type A), more specifically, rubber, silicone, elastomer, or the like. The cushioning members 18a to 18c reduce impact and vibration directly transmitted to the lenses 14 to 18, and fix the positions of the lenses 14 to 16 with respect to a plane vertical to the optical axis.

In a case where the rubber hardness of the cushioning members 18a to 18c is too low, meaning that they are too soft, such cushioning members 18a to 18c cause trouble in fixing the positions of the lenses 14 to 16 although they are effective in reducing impact and vibration. On the contrary, in a case where the rubber hardness of the cushioning members 18a to 18c is too high, meaning that they are too hard, the effect in reducing impact and vibration becomes low although the positions of the lenses 14 to 16 are tightly fixed. In this embodiment, therefore, a range of the rubber hardness of each of the cushioning members 18a to 18c is set in a range from at least 10 to at most 80. The positions of the lenses 14 to 16 in the optical axis direction are fixed at the forward edge of the barrel section 12a, at a step portion defined by the barrel section 12a and the barrel section 12b, and at a step portion defined by the barrel section 12b and the barrel section 12c, respectively.

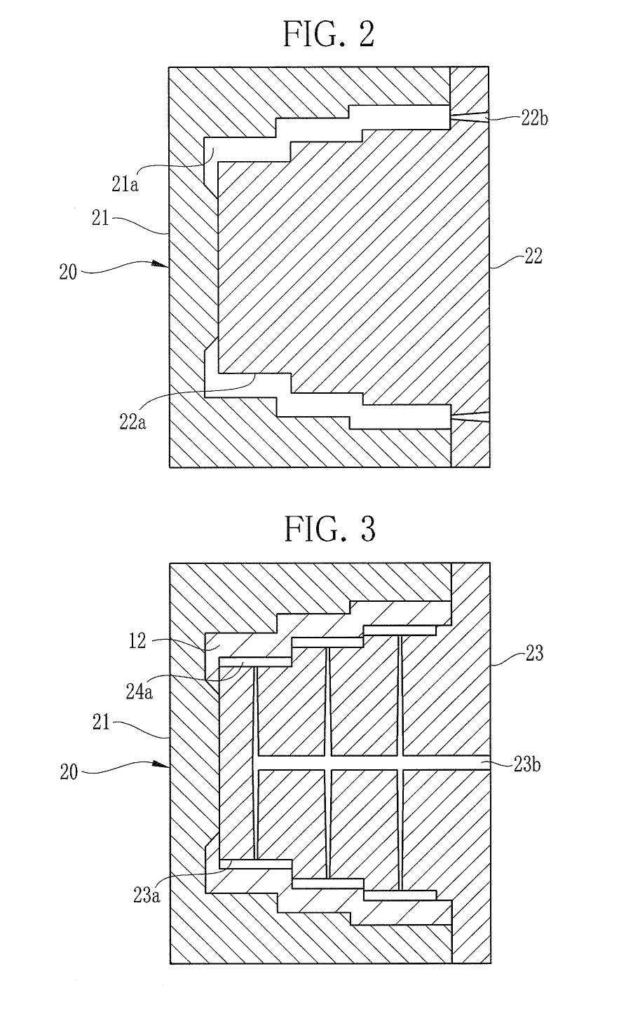

The cushioning members 18a to 18c are formed together with the lens barrel 12 by two-color molding (insert molding). Hereinafter, with reference to FIGS. 2 to 4, an example of a method for producing the lens device 10 (the lens barrel 12 and the cushioning member 18a to 18c) is described.

First, as shown in FIG. 2, the lens barrel 12 is formed using a mold 20. The mold 20 is constituted of a fixed mold 21, a first movable mold 22, and a second movable mold 23 (see FIG. 3) which will be described later. To open or close the mold 20, the first movable mold 22 or the second movable mold 23 is attached to or removed from the fixed mold 21.

A cavity 21a defining a shape of an outer circumferential surface of the lens barrel 12 is formed in the fixed mold 21. A convex portion 22a of the first movable mold 22 is inserted in the cavity 21a so as to close the mold 20. The outer circumferential surface of the convex portion 22a defines the inner circumferential surface of the lens barrel 12. Therefore, when the mold 20 is closed with the use of the convex portion 22a, the cavity 21a takes a form of the lens barrel 12. Then, a heated and melted lens barrel material (plastic, aluminum, or the like) is put in the cavity 21a through an opening 22b formed in the first movable mold 22, and then cooled. Thus, the lens barrel 12 is formed in the cavity 21a.

Thereafter, as shown in FIG. 3, the first movable mold 22 is removed from the fixed mold 21. Then, the mold 20 is closed by setting the second movable mold 23 in the fixed mold 21. Thereby, a convex portion 23a of the second movable mold 23 is inserted in the lens barrel 12 formed in the fixed mold 21. Cavities 24a having shapes of the cushioning members 18a to 18c are formed between the outer circumferential surface of the convex portion 23a and the inner circumferential surface of the lens barrel 12. After the mold 20 is closed, a heated and melted material (for example, silicone rubber) for forming the cushioning members 18a to 18c is put in the cavities 24a through an opening 23b formed in the second movable mold 23, and then cooled. Thus, the cushioning members 18a to 18c are formed inside the lens barrel 12.

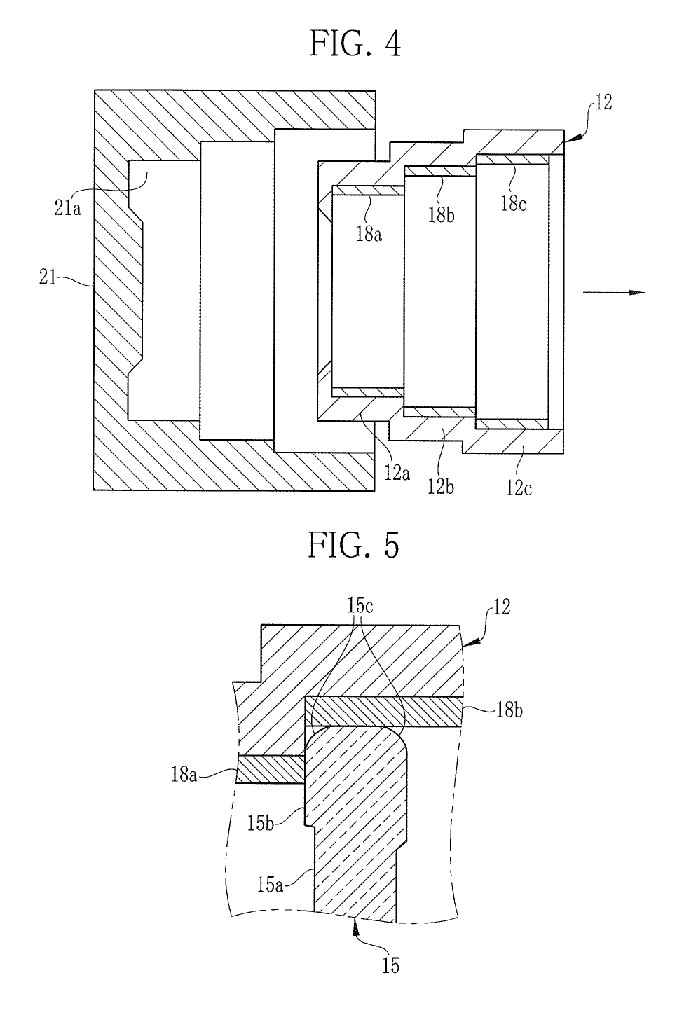

Thereafter, as shown in FIG. 4, the second movable mold 23 is removed from the fixed mold 21. Then, the lens barrel 12 is taken out from the fixed mold 21. Thus, the lens barrel 12 and, the cushioning members 18a to 18c are formed. After that, the lenses 14 to 16 are fixed to the inner circumferential surfaces of the cushioning members 18a to 18c, respectively, with an adhesive or like. Thus, the lens device 10 is produced.

In the present invention, as described above, the cushioning members 18a to 18b are provided between the rim surfaces of the lenses 14 to 16 formed from the nanocomposite material and the inner circumferential surfaces of the lens barrel 12, respectively. Thereby, direct contact between the lenses 14 to 16 and the lens barrel 12 are prevented. As a result, the chipping of the corner portions 14c to 16c of the lenses 14 to 16 (flanges 14b to 16b) due to coming in contact with the inner circumferential surfaces of the lens barrel 12 is prevented. In the same manner, portions of the lenses 14 to 16 other than the corner portions 14c to 16c are also prevented from chipping. In addition, the lenses 14 to 16 are prevented from being damaged when the lens device 10 is subject to impact. As a result, foreign matter caused by chipping of the lenses 14 to 16 is prevented in the lens barrel 12.

In the above embodiment, the cushioning members 18a to 18c are provided between the lenses 14 to 16 and the inner circumferential surfaces of the lens barrel 12, respectively, for preventing the chipping, in particular, of the corner portions 14c to 16c. However, the present invention is not limited to the above. For example, as shown in FIG. 5, R-chamfering as one type of chamfering processing may be performed to corner portions 14c to 16c, in addition to providing the cushioning members 18a to 18c. Although only the corner portions 15c of the second lens 15 are shown in FIG. 5, the R-chamfering is also performed to the corner portions 14c and 16c of the first and the third lenses 14 to 16. To prevent chipping of the lens, the R-chamfering or other type of chamfering may be performed to all the corner portions of the lens to eliminate sharp edges.

The R-chamfering of the corner portions 14c to 16c securely prevents chipping of the corner portions 14c to 16c even if impact and vibration are transmitted to the lenses 14 to 16 through the cushioning members 18a to 18c, respectively. Instead of the R-chamfering, other type of chamfering processing such as C-chamfering may be performed to the corner portions 14c to 16c. Various chamfering processing such as R-chamfering may be performed to corner portions other than the corner portions 14c to 16c of the lenses 14 to 16.

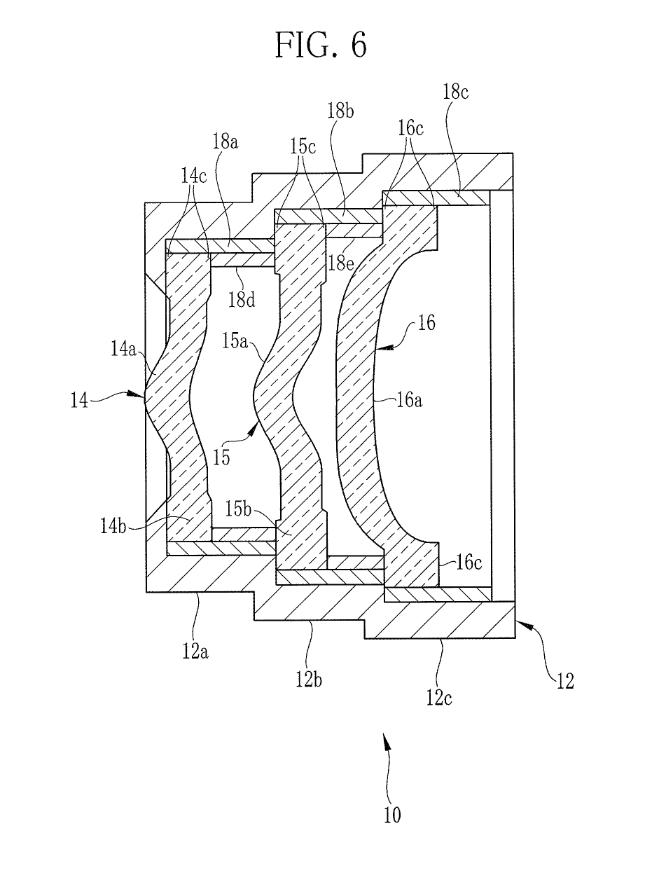

In the above embodiment, an example in which the cushioning members 18a to 18c are provided only between the lenses 14 to 16 and the lens barrel 12 is described. However, the present invention is not limited to the above. For example, as shown in FIG. 6, a fourth cushioning member (hereinafter may simply be referred to as cushioning member) 18d may be provided between the first lens 14 and the second lens 15, and a fifth cushioning member (hereinafter may simply be referred to as cushioning member) 18e may be provided between the second lens 15 and the third lens 16 in addition to cushioning members 18a to 18c.

The fourth cushioning member 18d has approximately annular shape, and is formed on the inner circumferential surface of the first cushioning member 18a. One end of the fourth cushioning member 18d comes in contact with the rear surface of the flange 14b while the other end comes in contact with the front surface of the flange 15b. The fifth cushioning member 18e is formed on the inner circumferential surface of the second cushioning member 18b. One end of the fifth cushioning member 18e comes in contact with the rear surface of the flange 15b while the other end comes in contact with the front surface of the flange 16c. Providing the cushioning member between the lenses 14 and 15, and between the lenses 15 and 16 further reduces impact and vibration transmitted to the lenses 14 to 16. Thus, the lenses 14 to 16 are further prevented from chipping.

In the above embodiment, an example in which the lens barrel 12 and the cushioning members 18a to 18c are formed by two-color molding (insert molding) is described. However, the present invention is not limited to the above. For example, the cushioning members 18a to 18c may be formed around the lenses 14 to 16, respectively, using a mold for known outsert molding. Thereafter, the lens barrel 12 may be formed so as to cover outer circumferential surfaces of the cushioning members 18a to 18c. The lens barrel 12 and the cushioning members 18a to 18c may be formed using a molding method other than outsert molding.

In the above embodiment, the approximately annular-shaped cushioning members 18a to 18e are described as an example. However, the present invention is not limited to the above. The shapes of the cushioning members 18a to 18e may be changed as necessary in accordance with a cross-sectional shape of the lens barrel 12 or shapes of the lenses 14 to 16. In addition, the number of lenses accommodated in the lens barrel 12 is not limited to three. The number of lenses may be more than or less than 3.

In the above embodiment, the first to the third cushioning members 18a to 18c are formed separately. Alternatively, the cushioning members 18a to 18c may be formed in one piece. In addition, the fourth and the fifth cushioning members 18d and 18e may be formed together with the first to the third cushioning members 18a to 18c in one-piece.

In the above embodiment, the lens device 10 for use in the mobile phone with the camera is described as an example. However, the present invention is not limited to the above. The present invention is applicable to a lens device for use in an image taking apparatuses other than the mobile phone with the camera such as a digital camera and a photographic camera, an image projecting apparatuses such as a projector, and the like.

Various changes and modifications are possible in the present invention and may be understood to be within the present invention.

### INDUSTRIAL APPLICABILITY

The present invention is preferably applied to a lens device having a lens barrel accommodating plastic lenses formed from plastic nanocomposite materials for use in various image taking apparatuses, image projecting apparatuses, and the like.

1. A lens device comprising:
a lens formed from a plastic nanocomposite material, said plastic nanocomposite material containing inorganic fine particles and thermoplastic polymer, said thermoplastic polymer having a functional group in at least one of a main chain end and a side chain, said functional group being chemically bonded to at least one of said inorganic fine particles;
a lens barrel accommodating said lens; and
a cushioning member provided between a rim surface of said lens and an inner circumferential surface of said lens barrel.

2. The lens device of claim 1, wherein chamfering is performed to a corner portion of said lens.

3. The lens device of claim 1, wherein rubber hardness in conformity with ISO (International Organization of Standardization) 7619 Type A of said cushioning member is in a range from at least 10 to at most 80.

4. The lens device of claim 1, wherein said lens barrel accommodates said plural lenses aligned along an optical axis direction and parallel to each other, and said cushioning member extends in said optical axis direction so as to contact with said adjacent lenses.
